(19) United States
(12) Patent Application Publication
(10) Pub. No.: US 2017/0102591 A1
(43) Pub. Date: Apr. 13, 2017

(54) LIQUID CRYSTAL DISPLAY DEVICE

(71) Applicant: SAMSUNG DISPLAY CO., LTD., Yongin-si (KR)

(72) Inventors: Su Jung HUH, Yongin-si (KR); Yeon Mun JEON, Hwaseong-si (KR); Tae Hyung HWANG, Seoul (KR)

(21) Appl. No.: 15/147,193

(22) Filed: May 5, 2016

(30) Foreign Application Priority Data
Oct. 7, 2015 (KR) 10-2015-0140772

(51) Int. Cl. G02F 1/1343; G02F 1/1335; G02F 1/1339; G02F 1/1362

(52) U.S. Cl. CPC G02F 1/134336; G02F 1/136286; G02F 1/133512; G02F 1/13394

(57) ABSTRACT

A liquid crystal display device includes a first substrate, a second substrate disposed opposite to the first substrate, where a plurality of pixel regions is defined in the first or second substrate, a liquid crystal layer disposed between the first substrate and the second substrate, and a pixel electrode including: a body portion disposed in a pixel region on the first substrate, where a slit is defined in the body portion; an extension disposed on the first substrate near a boundary line of the pixel region to be spaced apart from the body portion and extending in a first direction, where an opening is defined between the body portion and the extension bar and extends in the first direction; and a connection electrode disposed on the first substrate and which electrically connects the body portion and the extension bar.

This application claims priority to Korean Patent Application No. 10-2015-0140772, filed on Oct. 7, 2015, and all the benefits accruing therefrom under 35 U.S.C. §119, the content of which in its entirety is herein incorporated by reference.

### BACKGROUND

1. Field

Embodiments of the invention relate to a liquid crystal display device.

2. Description of the Related Art

In general, a liquid crystal display device is a device, in which a liquid crystal layer is disposed between two insulating substrates including a pair of field-generating electrodes therein, and the transmittance of light passing through the liquid crystal layer thereof is adjusted to display a desired image by applying a voltage to the field-generating electrodes to rearrange liquid crystal molecules of the liquid crystal layer.

A display device of a twisted nematic (“TN”) mode, in which a pair of field-generating electrodes is provided in each of the two insulating substrates, is widely used in recent. The liquid crystal display device of the TN mode may have a narrow viewing angle. The liquid crystal display devices of various modes for ensuring the wide viewing angle have been developed, and a liquid crystal display panel of a plane to line switching (“PLS”) mode may be adopted to improve the viewing angle.

The liquid crystal display panel of the PLS mode typically displays an image, by disposing a pixel electrode and a common electrode as field-generating electrodes to be insulated from each other on a substrate (e.g., an array substrate) in which thin film transistors as switching elements are formed, and by adjusting the light transmittance by the liquid crystal particles oriented depending on a fringe field that is abandoned through a slit of a vertical/horizontal shape formed on the pixel electrode or the common electrode.

### SUMMARY

In a liquid crystal display panel including a pixel electrode that includes a slit of a horizontal shape, a fringe field may not be formed by the liquid crystal located in a vertical boundary between pixels, that is, in a region superimposed with a data line, or even if the fringe field is formed, the fringe filed may have an intensity enough to control the liquid crystal. In the case of the liquid crystal located in the region in which the voltage control is not smooth, a liquid crystal texture may become unstable, such as an easy change in a rotation angle of the liquid crystal caused by an external force such as an external pressure through a finger. Accordingly, a white bruising may occur in which, when driven in a white mode, the liquid crystal texture located in the region in which the voltage control is not smooth is pushed into the slip by the external force, and a stain is displayed.

Embodiments of the invention relate to a liquid crystal display device having a structure that prevents white bruising.

In an embodiment of the liquid crystal display according to the invention, a pixel electrode structure includes a slit of a horizontal shape, such that a horizontal field is applied to the liquid crystal located in the vertical boundary between pixels, i.e., at a region superimposed with the data line, thereby effectively preventing an occurrence of white bruising.

In an exemplary embodiment of the invention, a liquid crystal display device includes: a first substrate, a second substrate disposed opposite to the first substrate, where a plurality of pixel regions is defined in the first substrate or the second substrate, a liquid crystal layer disposed between the first substrate and the second substrate, and a pixel electrode including a body portion disposed in a pixel region on the first substrate, where a slit is defined in the body portion, an extension bar disposed on the first substrate near a boundary line of the pixel region to be spaced apart from the body portion and extending in a first direction, where an opening is defined between the body portion and the extension bar and extends in the first direction, and a connection electrode disposed on the first substrate and which electrically connects the body portion and the extension bar.

### BRIEF DESCRIPTION OF THE DRAWINGS

The above and other aspects and features of the invention will become more apparent by describing in detail exemplary embodiments thereof with reference to the attached drawings, in which:

FIG. 1 is a plan view of a liquid crystal display device according to an embodiment of the invention;

FIG. 2 is a cross-sectional view taken along line II-II′ of FIG. 1;

FIG. 3 is a plan view illustrating a pixel electrode structure of a liquid crystal display according to an embodiment of the invention;

FIG. 4 is a plan view illustrating a pixel electrode structure of the liquid crystal display device according to an alternative embodiment of the invention; and

FIGS. 5 to 10 are plan views illustrating a pixel electrode structure of a liquid crystal display device according to other alternative embodiments of the invention.

### DETAILED DESCRIPTION

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. “Or” means “and/or.” As used herein, the term “and/or” includes any and all combinations of one or more of the associated listed items. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, embodiments of the invention will be described with reference to the attached drawings.

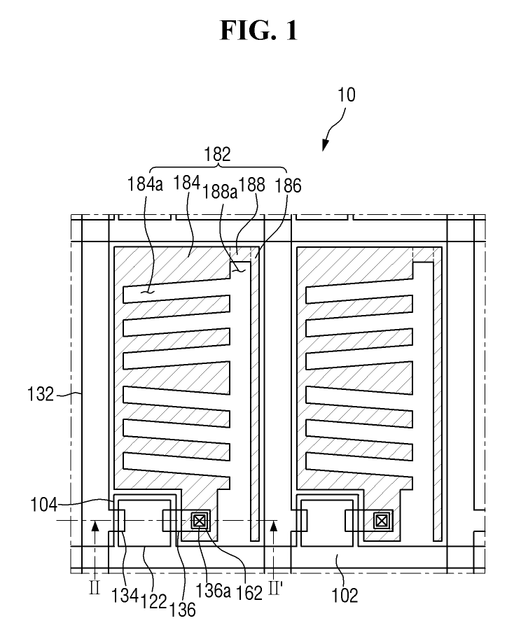

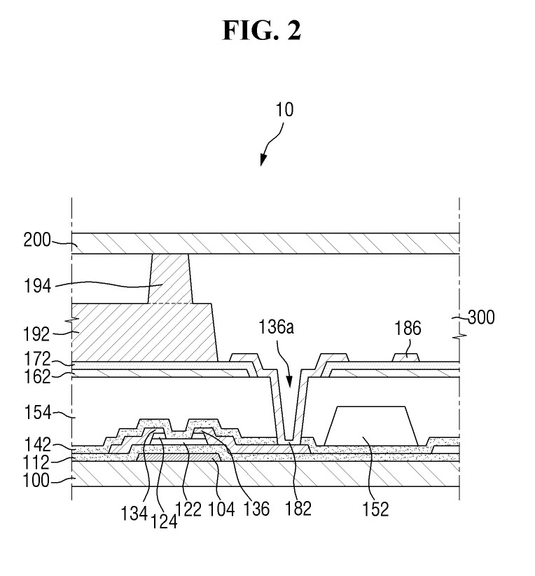

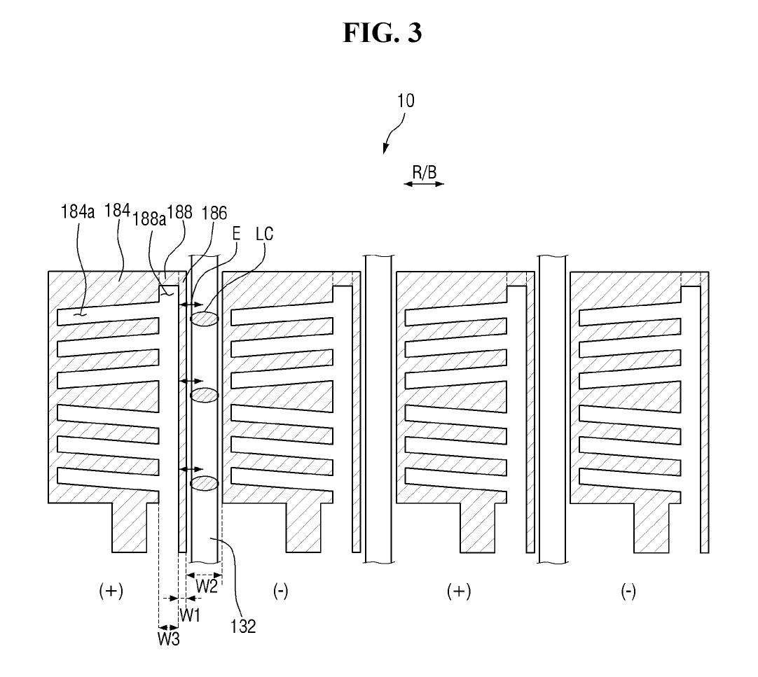

FIG. 1 is a plan view of a liquid crystal display device according to an embodiment of the invention. FIG. 2 is a cross-sectional view taken along line II-II′ of FIG. 1. FIG. 3 is a plan view for illustrating a pixel electrode structure of the liquid crystal display according to an embodiment of the invention.

Referring to FIGS. 1 to 3, a liquid crystal display device 10, according to an embodiment of the invention, includes a first substrate 100, a second substrate 200 opposite to the first substrate 100, and a liquid crystal layer 300 interposed between the first substrate 100 and the second substrate 200.

The first substrate 100 and the second substrate 200 may include an insulating material, such transparent glass, quartz, ceramics, silicone or a transparent plastic, for example. The first substrate 100 and the second substrate 200 may be disposed to face each other.

In some embodiments, the first substrate 100 and the second substrate 200 may be flexible. In such an embodiment, the first substrate 100 and the second substrate 200 may be a substrate which may be changed in form by rolling, folding, bending and the like. In one exemplary embodiment, for example, the first substrate 100 and the second substrate 200 may each independently have a Young's modulus (i.e., a tensile modulus) of about 0.01 to 300 gigaPascals (GPa), e.g., about 0.001 to about 1 GPa, or about 0.05 to about 0.5 GPa.

A plurality of gate wirings 102, 104, and data wirings 132, 134, 136b may be disposed on the first substrate 100.

The gate wirings 102, 104 may include a plurality of gate lines 102 and a plurality of gate electrodes 104. The data wirings 132, 134, 136 may include a plurality of data lines 132, a plurality of source electrodes 134, and a plurality of drain electrodes 136.

In an embodiment, the gate wirings 102, 104 or the data wirings 132, 134, 136 may include or be made of an aluminum-based metal such as aluminum (Al) and aluminum alloy, a silver-based metal such as silver (Ag) and a silver alloy, a copper-based metal such as copper (Cu) and a copper alloy, a molybdenum-based metal such as molybdenum (Mo) and a molybdenum alloy, chromium (Cr), titanium (Ti) and tantalum (Ta). In such an embodiment, the gate wirings 102, 104 or the data wirings 132, 134, 136 may have a multi-film (or multi-layer) structure including two conductive films or layer (not illustrated) having the physical properties different from each other. In one embodiment, for example, the gate wirings 102, 104 or the data wirings 132, 134, 136 may include a single conductive film including or formed of an aluminum-based metal, a silver-based metal, a copper-based metal or the like, and another conductive film including or formed of a molybdenum-based metal, chromium, titanium, tantalum or the like. In one embodiment, for example, the gate wirings 102, 104 or the data wirings 132, 134, 136 may include a chromium lower film and an aluminum upper layer, and an aluminum lower film and a molybdenum upper layer. However, the invention is not limited thereto, and the gate wiring 102, 104 and the data wirings 132, 134, 136 may include or be formed of various metals and conductors.

Each gate line 102 may extend along a boundary of pixels in a first direction, for example, in a horizontal direction, and each data line 132 may extend along a boundary of the pixels in a second direction, for example, in a vertical direction. The gate line 102 and the data line 132 may intersect with each other and may define a plurality of pixel regions. In one embodiment, for example, the pixel region may be defined by a region that is surrounded by the gate line 102 and the data line 132, but not being limited thereto. Although it is not illustrated, in some embodiments, the data line 132 may be regularly bent for improving the transmittance, but it is not limited thereto.

A gate electrode 104 of each pixel is connected to a corresponding gate line 102. The gate electrode 104 branches from the gate line 102 toward the semiconductor layer 122 or may be defined by an extension of the gate line 102. However, it is not limited thereto, and the gate electrode 104 may be defined in a region that overlaps the semiconductor layer 122 on the extension path of the gate line 102.

A source electrode 134 of each pixel is connected to a corresponding data line 132. The source electrode 134 branches from the data line 132 toward the semiconductor layer 122 or may be formed by extension of the data line 132. However, it is not limited thereto, and a source electrode 104 may be defined in a region that overlaps the semiconductor layer 122 on the extension path of the data line 132. In one embodiment, for example, a source electrode 104 may not protrude from the data wirings 132 and may be located on the substantially same line as the data line 132. The drain electrode 136 may be disposed to be spaced apart from the source electrode 104 or dispose opposite side from the source electrode with respect to the semiconductor layer 122. The drain electrode 136 may be electrically connected to the pixel electrode 182 through a contact hole 136a defined or formed through a first protective layer 142 and an organic layer 154.

A gate insulating film 112 may be disposed between the gate wirings 102, 104 and the data wirings 132, 134, 136. In an embodiment, the gate insulating film 112 is disposed on the gate wirings 102, 104, and the data wirings 132, 134, 136 may be disposed on the gate insulating film 112. The gate insulating film 112, for example, may include or be formed of silicon nitride (SiNx), silicon oxide (SiO₂), silicon oxynitride (SiON) or a laminated film thereof. The gate insulating film 112 may serve to maintain the insulation between the gate wirings 102, 104 and a conductive thin film such as a data line 132 located above the gate wirings.

The semiconductor layer 122 is disposed on the gate insulating film 112. in one embodiment, for example, the semiconductor layer 122 may include or be formed of hydrogenated amorphous silicon or polycrystalline silicon. The semiconductor layer 122 is disposed to at least partially overlap the gate electrode 104. The semiconductor layer 122, the gate electrode 104, the source electrode 134 and the drain electrode 136 constitute or collectively defined a thin film transistor.

The semiconductor layer 122 may have various shapes such as an island shape or a linear shape, and FIG. 3 illustrates an embodiment where the semiconductor layer 122 is in an island shape, but it is not limited thereto. In an embodiment, where the semiconductor layer 122 is in a linear shape (not illustrated), the semiconductor layer 122 may overlap the data wirings 132, 134, 136.

An ohmic contact layer 124 including or formed of a n+ hydrogenated amorphous silicon doped with n-type impurity at a high concentration may be disposed on the semiconductor layer 122. The ohmic contact layer 124 is located between the lower semiconductor layer 122 and the upper source electrode 134 and the drain electrode 136 to serve to reduce the contact resistance. The ohmic contact layer 124 may have various shapes such as an island shape or a linear shape corresponding to a shape of the semiconductor layer 122. In an embodiment, where the semiconductor layer 122 has an island shape, the ohmic contact layer 124 may also have an island shape. In an alternative embodiment, where the semiconductor layer 122 has a linear shape, the ohmic contact layer 124 may also have a linear shape. In an embodiment, where the source electrode 134 and the drain electrode 136 are spaced apart while facing each other, the ohmic contact layer 124 may expose a portion of the semiconductor layer 122 corresponding to a space between the source electrode 134 and the drain electrode 136. In the semiconductor layer 122, a channel may be formed in a region in which the source electrode 134 and the drain electrode 136 are spaced apart to face each other.

When the gate electrode 104 receives a gate-on signal and the channel is formed in the semiconductor layer 122, a thin film transistor is turned on, and the drain electrode 136 may receive the data signal from the source electrode 134 and transmit a data voltage corresponding to the data signal to the pixel electrode 182.

A first protective layer 142 (passivation layer) is disposed on the data wirings 132, 134, 136 and the exposed semiconductor layer 122. A contact hole 136a that exposes at least a part of the drain electrode 136 may be defined or formed in the first protective layer 142 and an organic layer 154 described below. At least a part of the drain electrode 136 exposed through the contact hole 136a may be in contact with the pixel electrode 182. Thus, the drain electrode 136 and the pixel electrode 182 may be electrically connected to each other.

The first protective layer 142, for example, may include inorganic substances such as silicon nitride or silicon oxide, and substances such as a-Si: C: O and a-Si: O: F, and may be formed by a plasma enhanced chemical vapor deposition (“PECVD”).

The organic layer 154 may be disposed on the first protective layer 142. The organic layer 154 may include a material having high planarization characteristics and photosensitivity. A contact hole 136a that exposes at least a part of the drain electrode 136 may be defined through the organic layer 154.

In some embodiments, as illustrated in FIG. 2, a color filter 152 may be disposed between the organic layer 154 and the first protective layer 142. The color filter 152 may include a red (“R”) color filter, a green (“G”) color filter and a blue (“B”) color filter. Each of the R, G and B color filters is disposed in a pixel or a unit pixel defined by R, G, and B pixels. The color filter 152 may be disposed to overlap the pixel electrode 182. The color filter 152 may include a photosensitive organic material including a pigment. The organic layer 154 is disposed on the color filter 152 and may flatten the steps of the R, G, and B color filters. The color filter 152 may be covered by the organic layer 154. In an embodiment, the color filter 152 is covered by an organic layer 154 and may not have an exposed portion, but the invention is not limited to such a structure.

A common electrode 162 may be disposed on the organic layer 154. The common electrode 162 may receive the common voltage to generate an electric field with the pixel electrode 182 to control the alignment direction of liquid crystal molecules contained in the liquid crystal layer 300. The common electrode 162 may overlap the pixel electrode 182. An opening that exposes a region corresponding to the contact hole 136a may be defined or formed through the common electrode 162. In such an embodiment, at least a part of the drain electrode 136 may be exposed through the opening in the common electrode 162. The common electrode 162 may be integrally formed as a single unitary and indivisible unit over the entire pixel region surrounded by the gate line 102 and the data line 132 except the opening. The common electrode 162 may include a transparent conductive material such as indium tin oxide (“ITO”) or indium zinc oxide (“IZO”), but not being limited thereto.

In some embodiments, as illustrated in FIG. 2, the common electrode 162 may be disposed below the pixel electrode 182, but not being limited thereto. In an alternative embodiment, the common electrode may be disposed above the pixel electrode. In such an embodiment, the common electrode includes a slit, and the pixel electrode may have a plate shape.

A second protective layer 172 may be disposed on the common electrode 162 and the organic layer 154. An opening that exposes a region corresponding to the contact hole 136a is defined through the second protective layer 172. In such an embodiment, at least a part of the drain electrode 136 may be exposed through the opening defined or formed in the second protective layer 172. The second protective layer 172 may be an inorganic insulator. In one embodiment, for example, the second protective layer 172 may contain silicon nitride, silicon oxide and the like. The second protective layer 172 may be located between the pixel electrode 182 and the common electrode 162 to insulate the common electrode 162 and the pixel electrode 182 to each other.

The pixel electrodes 182 may be disposed on the second protective layer 172 for each unit pixel, e.g., a pixel region of each unit pixel. At least a part of the pixel electrode 182 may be superimposed with, or overlaps, the common electrode 162. A part of the pixel electrode 182 is disposed in the contact hole 136a, e.g., on an inner surface of the layers in which the contact hole 136a is defined. A part of the pixel electrode 182 disposed inside the contact hole 136a may be in contact with the drain electrode 136 and may be electrically connected thereto.

When the data voltage is applied to the pixel electrode 182 through the contact hole 136a, an electric field is formed in a direction of the lower common electrode 162 from the pixel electrode 182. In such an embodiment, the pixel electrode 182 may rotate the liquid crystal molecules contained in the liquid crystal layer 300, by forming an electric field with the common electrode 162. The pixel electrode 182 may contain, but not limited to, a transparent conductive material such as ITO or IZO, for example.

The structure of the pixel electrode 182 will be described in greater detail below.

A light-shielding pattern 192 may be disposed on the second protective layer 172 and the pixel electrode 182. The light-shielding pattern 192 serves to prevent the light leakage. The light-shielding pattern 192 may be disposed in the thin film transistor region and a non-pixel region (a region between the pixels, or the gate line and data line region). The light-shielding pattern 192 may be disposed along the boundary region of the pixel region.

The light-shielding pattern 192 may include a black organic polymeric material including a black dye or pigment, or a metal (metal oxide) such as chromium and chromium oxide.

A column spacer 194 is disposed between the first substrate 100 and the second substrate 200 to maintain an interval between the first substrate 100 and the second substrate 200, and in some embodiments, an end portion of the column spacer 194 may be in contact with the second substrate 200 side as illustrated in FIG. 2, but not being limited thereto. In an alternative embodiment, the end portion of the column spacer 194 may be disposed to be spaced apart from the second substrate 200 at a predetermined distance.

Although not illustrated, the column spacer 194 may include a plurality of column spacers having different steps or heights. In one embodiment, for example, the column spacer 194 may include a main column spacer having a relatively high step and a sub-column spacer having a relatively low step. In such an embodiment, the interval between the first substrate 100 and the second substrate 200 may be primarily maintained by the main column spacer, and when the main column spacer does not effectively perform the function, the interval between the first substrate 100 and the second substrate 200 may be secondarily maintained by the sub-column spacer.

Referring to FIG. 2, the column spacer 194 may be disposed on the light-shielding member 192. The column spacer 194 may be disposed in a region corresponding to the thin film transistor. At least a part of the column spacer 194 may be superimposed with, or overlaps, the gate wirings 102, 104. However, the arrangement of the column spacer 194 is not limited thereto.

In some embodiments, the column spacer 194 may include the same material as the light-shielding member 192. In an embodiment, the column spacer 194 and the light-shielding member 192 may be integrally formed as a single unitary and indivisible unit. In one embodiment, for example, through a half-tone mask or a slit mask exposure, the column spacer 194 and the light-shielding member 192 may be provided or formed through the same patterning step of the same material.

Although the embodiment of FIG. 2 illustrates an embodiment where the light-shielding member 192 is disposed on the second protective layer 172, but the invention is not limited thereto. In an alternative embodiment, the light-shielding member 192 may be disposed in a region corresponding to the thin film transistor region and the non-pixel region (between the pixels, the gate line and data line region) in the second substrate 200. In such an embodiment, the color filter 152 may be disposed on the second substrate 200. In an embodiment, the color filter may be disposed in the pixel region to overlap the pixel electrode. A part of the color filter extends up to the light-shielding member located in the pixel boundary and may partially overlap the light-shielding member.

An alignment film (not illustrated) may be disposed on each of a surface of the first substrate 100 and a surface of the second substrate 200 that face the liquid crystal layer 300. In an embodiment, an alignment film (not illustrated) on which the liquid crystal layer 300 may be aligned may be disposed on the pixel electrode 182, the second protective layer 172, the light-shielding pattern 192 and the column spacer 194.

A liquid crystal layer 300 including liquid crystal molecules having positive dielectric anisotropy or negative dielectric anisotropy may be interposed between the first substrate 100 and the second substrate 200.

Hereinafter, the structure of the pixel electrode 182 of the liquid crystal display device 10 according to an embodiment of the invention will be described in detail.

Referring to FIGS. 1 and 3, the pixel electrode 182 of the liquid crystal display device 10 according to an embodiment of the invention includes a body portion 184, an extension bar 186 and an opening 188a.

The body portion 184 of the pixel electrode 182 is disposed in each pixel region and includes a slit 184a. A fringe electric field may be formed in a direction of the lower common electrode 162 by the slit 184a formed in the body portion 184.

In some embodiments, as illustrated in FIGS. 1 and 3, the slit 184a of the body portion 184 may be formed to provide a vertical double domain that is capable of aligning a liquid crystal director in different directions. When the slit is provided in a vertical double domain, as illustrated in FIGS. 1 and 3, the slit 184a may be provided in a shape that is vertically symmetrical with respect to an imaginary horizontal center line (not illustrated). However, the invention is not limited thereto, and the pixel electrode 182 may provide a triple or more multi-domain, or a single domain.

In some embodiments, as illustrated in FIGS. 1 and 3, the slit 184a may be tilted to form an oblique angle with respect to the imaginary horizontal direction. With respect to the imaginary horizontal center line of the pixel electrode 182, the upper slit 184a diagonally extends in a right upward direction, and the lower branch electrode 184 may diagonally extend in a right downward direction. Although the tilted degree of the slit 184a based on the imaginary horizontal center line of the pixel electrode 182 may be, but not limited to, equal to or less than about 20 degrees.

In some embodiments, as illustrated in FIGS. 1 and 3, the slit 184a may have a structure with an open end. In such an embodiment, an end of the slit 184a connected to an opening 188a. However, this is merely an exemplary structure, and the invention is not limited thereto.

The extension bar 186 of the pixel electrode 182 is disposed on the boundary side of the pixel, and may have a shape that extends in the first direction. Herein, the boundary of pixel refers to the gate line 102 and the data line 132 that define a pixel region, and the boundary of pixel refers to an inner region adjacent to the boundary of the pixel, including the regions of the gate line 102 and the data line 132 that define the pixel region. In one embodiment, for example, as illustrated in FIG. 1, the extension bar 186 is disposed inside the pixel region and may be disposed adjacent to the data line 132 corresponding to the boundary of pixel. However, this is merely an exemplary structure, and the invention is not limited thereto.

The extension bar 186 may extend in the same direction as the extension direction of the lower signal lines, for example, the data line 132 or the gate line 102. In one embodiment, for example, as illustrated in FIGS. 1 and 3, the extension bar 186 may have a shape that extends in the same direction as the extension direction of the data line 132, that is, in the vertical direction.

The extension bar 186 is disposed to be spaced part from the body portion 184. The opening 188a is formed in a region in which the body portion 184 and the extension bars 186 are spaced apart from each other. The opening 188a may have a shape that extends in the first direction. In an embodiment, the opening 188a may have a shape that extends in the same direction as the extension direction of the extension bar 186.

In some embodiments, a width W1 of the extension bar 186 may be in a range of about 2 micrometers (μm) to about 8 μm, and a spaced distance W2 between the extension bar 186 and the body portion of the pixel electrode adjacent in the horizontal direction may be equal to or less than about 5 μm, and a width W3 of the opening 188a may be equal to or less than about 7.5 μm. However, such dimensions are merely exemplary and the invention is not limited thereto. Although it is not illustrated, in an embodiment, the width of the opening 188a may be larger than a spaced distance between the extension bar 186 and the body portion of the adjacent pixel. In such an embodiment, the extension bar 186 may be disposed to be closer to the body portion of the pixel electrode adjacent in the row direction than the body portion of the pixel electrode 184. In an embodiment, the width of the opening 188a may be about 1.2 times to about 1.5 times greater than the spaced distance between the extension bar 186 and the body portion of the adjacent pixel. However, such width or distance is merely exemplary, and the relation between the width and the spaced distance is not limited thereto. In an alternative embodiment, the width of the opening 188a may be smaller than the spaced distance between the extension bar 186 and the body portion of the adjacent pixel.

The body portion 184 and the extension bars 186 are electrically connected to each other. The body portion 184 and the extension bars 186 may be electrically connected to each other by a connection electrode 188. In such an embodiment, an end of the connection electrode 188 is connected to the body portion 184, and another end may be connected to the extension bar 186. The connection electrode 188 may have a shape that extends in the extension direction of the extension bar 186, i.e., the second direction substantially perpendicular to the first direction, but not being limited thereto.

In some embodiments, as illustrated in FIGS. 1 and 3, the connection electrode 188 is disposed on the first substrate 100 and may be connected to one end of the body portion 184 and one end of the extension bar 186. In such an embodiment, the connection electrode 188 may be located in an edge portion of the spaced region between the body portion 184 and the extension bars 186. In such an embodiment, the connection electrode 188 may be disposed in the outermost portion of the spaced region between the body portion 184 and the extension bars 186. However, the invention is not limited thereto.

In some embodiments, as illustrated in FIGS. 1 and 3, the connection electrode 188 may be disposed on a same level or directly on a same layer, as the body portion 184 and the extension bars 186, but not being limited thereto. Alternatively, the connection electrode 188 may be disposed in a layer different from the body portion 184 and the extension bars 186 and is connected to the body portion 184 and the extension bar 186 through the contact structure.

In an embodiment shown in FIGS. 1 to 3, the fringe field is not formed by the liquid crystal located in the vertical boundary between the pixels, e.g., in the region superimposed with, or overlaps, the data line, or even if the fringe field is formed, the fringe field may have substantially small intensity which is not enough to control the liquid crystal. In the case of the liquid crystal located in the region in which the voltage control is not smooth, a liquid crystal texture may become unstable, which may be due to an easy change in a rotation angle of the liquid crystal caused by an external force such as an external pressure through a finger. Accordingly, a white bruising may occur in which, when driven in a white mode, the liquid crystal texture located in the region in which the voltage control is not smooth is pushed into the slip by the external force, and a stain is displayed.

An embodiment of a liquid crystal display device has the above-mentioned white bruising prevention structure. In an embodiment, where the pixel electrode 182 of the liquid crystal display device 10 includes an extension bar 186 disposed to extend in the first direction on the boundary side of the pixel, an electric field may be to a liquid crystal disposed on the boundary side of the pixel, that is, a liquid crystal located in the region in which the voltage control is not smooth, and a result, the liquid crystal may have a strong degree which tends to maintain the orientation angle. Thus, even when an external force is generated in the region in which the voltage control is not smooth, an occurrence degree of the white bruising may be weakened as compared to the structure having no extension bar 186.

In an embodiment, as shown in FIG. 3, when a rubbing direction R/B is in the horizontal direction and the positive dielectric anisotropy liquid crystal is used, the electric field E may be formed in the horizontal direction by the extension bar 186. The liquid crystal LC disposed on the boundary side of the pixel by formed electric field E, for example, the data line 132 region has a strong degree in which a major axis of a liquid crystal molecule tends to be arranged to face the horizontal direction, and thus, even when an external force is generated, an occurrence degree of the white bruising may be weakened as compared to a structure that has no extension bar 186.

In some embodiments, the liquid crystal display device 10 includes a first pixel electrode, and a second pixel electrode adjacent to the first pixel electrode in the second direction, and at the same gate-on timing, data voltages with polarities different from each other may be provided to the first pixel electrode and the second pixel electrode. Here, the data voltages of the different polarities may be set based on the voltage applied to the common electrode. That is, it is possible to perform a control through a data driver (not illustrated) so that the voltage applied to the first pixel electrode is greater than the voltage applied to the common electrode and the voltage applied to the second pixel electrode is smaller than the voltage applied to the common electrode during a first time interval, and the voltage applied to the first pixel electrode is smaller than the voltage applied to the common electrode and the voltage applied to the second pixel electrode is greater than the voltage applied to the common electrode during a second time interval continuous with the first time interval.

Specifically, referring to FIG. 3, when the pixel electrodes disposed in a right direction from a left pixel electrode are referred to as a first pixel electrode, a second pixel electrode, a third pixel electrode and a fourth pixel electrode, respectively, during the first time period, the polarity of the voltage applied to the first pixel electrode may have a positive (+) polarity, the polarity of the voltage applied to the second pixel electrode may have a negative (−) polarity, the polarity of the voltage applied to the third pixel electrode may have a positive (+) polarity, and the polarity of the voltage applied to the fourth pixel electrode may have a negative (−) polarity. The polarity of each pixel electrode may be changed during the second time interval immediately following the first time interval. In such an embodiment, it is possible to achieve an inversion driving method in which voltages of different polarities are alternately and repeatedly applied between the adjacent pixel electrodes. However, this is merely exemplary, and alternatively, the polarity of the voltage applied between the adjacent pixel electrodes are the same, and the voltage greater than the voltage applied to the common electrode and the voltage smaller than the voltage applied to the common electrode may be repeatedly and alternately applied between the adjacent pixel electrodes.

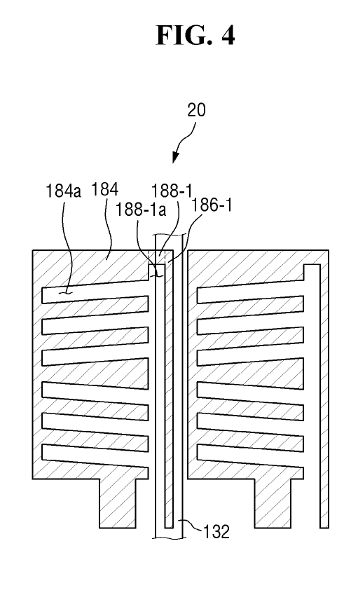

FIG. 4 is a plan view for illustrating a structure of a pixel electrode of a liquid crystal display device according to an alternative embodiment of the invention.

Referring to FIG. 4, an alternative embodiment of a liquid crystal display device 20 is substantially the same as an embodiment of the liquid crystal display device 10 described above with reference to FIGS. 1 to 3 except for an extension bar 186-1, a connection electrode 188-1 and an opening 188-1a of the pixel electrode. The same or like elements shown in FIG. 4 have been labeled with the same reference characters as used above to describe the embodiments of the liquid crystal display device shown in FIGS. 1 to 3, and any repetitive detailed description thereof will hereinafter be omitted or simplified.

In some embodiments, at least a part of the extension bar 186-1 may be superimposed with the lower signal line. In one embodiment, for example, as illustrated in FIG. 4, the extension bar 186-1 may be fully superimposed with a data line 132 disposed at the bottom. However, this is an example, and only a part of the extension bars 186-1 may be superimposed with the lower signal line. Furthermore, although the data line 132 is illustrated as the lower signal line, it is not limited thereto, and the signal line may also be provided as the gate line 102.

In some embodiments, at least a part of the connection electrode 188-1 may be superimposed with the data line 132. In one embodiment, for example, as illustrated in FIG. 4, a portion of the connection electrode 188-1 connected with the extension bar 186-1 may be superimposed with the data line 132. However, this is an exemplary structure, and the invention is not limited thereto.

In some embodiments, at least a part of the opening 188-1a may be superimposed with the data line 132. In one embodiment, for example, as illustrated in FIG. 4, as the extension bar 186-1 is located inside the region of the data line 132, a part of the opening 188-1a may be superimposed with the data line 132. However, this is an exemplary structure, and the invention is not limited thereto.

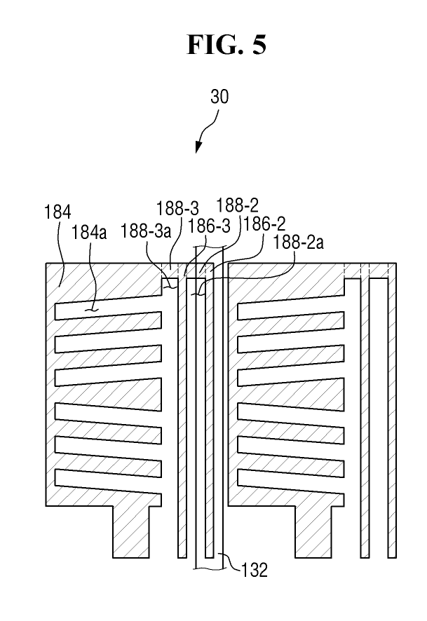

FIG. 5 is a plan view illustrating a pixel electrode structure of a liquid crystal display device according to another alternative embodiment of the invention.

Referring to FIG. 5, an alternative embodiment of a liquid crystal display device 30 is substantially the same as an embodiment of the liquid crystal display device 10 described above with reference to FIGS. 1 to 3 except for the pixel electrode, e.g., the extension bars 186-2, 186-3, the connection electrodes 188-2, 188-3 and the openings 188-2a, 188-3a thereof. The same or like elements shown in FIG. 5 have been labeled with the same reference characters as used above to describe the embodiments of the liquid crystal display device shown in FIGS. 1 to 3, and any repetitive detailed description thereof will hereinafter be omitted or simplified.

In some embodiments, the extension bars 186-2, 186-3 of the pixel electrode include a plurality of extension bars, the connection electrodes 188-2, 188-3 includes a plurality of connection electrodes, and the openings 188-2a, 188-3a may include a plurality of openings. In one embodiment, for example, referring to FIG. 5, the extension bars 186-2, 186-3 may include a first extension bar 186-2 and a second extension bar 186-3, the connection electrodes 188-2, 188-3 may include a first connection electrode 188-2 and a second connection electrode 188-3, and the openings 188-2a, 188-3a may include a first opening 188-2a and a second opening 188-3a.

The first extension bar 186-2 and the second extension bar 186-3 are disposed on the boundary side of the pixel. As illustrated in FIG. 5, the first extension bar 186-2 is disposed to overlap the signal line disposed therebelow, for example, the data line 132, and the second extension bar 186-3 is disposed on the inside of the pixel region and may be disposed adjacent to the data line 132 corresponding to the boundary of the pixel.

One end of the first connection electrode 188-2 is connected to the first extension bar 186-2, and the other end thereof may be connected to the second extension bar 186-3. One end of the second connection electrode 188-3 is connected to the second extension bar 186-3, and the other end thereof may be connected to the body portion 184.

In some embodiments, at least a part of the first connection electrode 188-2 may be superimposed with, or overlaps, the data line 132. In one embodiment, for example, as illustrated in FIG. 5, a part of the first connection electrode 188-2 connected with the first extension bar 186-2 may be superimposed with, or overlaps, the data line 132. However, this is merely exemplary, and the invention is not limited thereto.

The first opening 188-2a may be formed in a spaced region between the first extension bar 186-2 and the second extension bar 186-3. The second opening 188-3a may be formed in a spaced region between the body portion 184 and the second extension bar 186-3. The first opening and 188-2a and the second opening 188-3a may have a shape that extends in the same direction as the extension direction of the first extension bar 186-2 and the second extension bar 186-3.

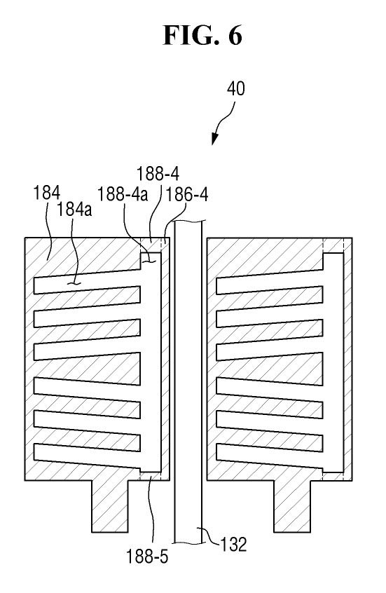

FIG. 6 is a plan view illustrating a pixel electrode structure of the liquid crystal display device according to another alternative embodiment of the invention.

Referring to FIG. 6, an alternative embodiment of a liquid crystal display device 40 is different from the liquid crystal display device 10 described through FIGS. 1 to 3 substantially the same as an embodiment of the liquid crystal display device 10 described above with reference to FIGS. 1 to 3 except for the pixel electrode, e.g., the connection electrodes 188-4, 188-5 and an opening 188-4a thereof. The same or like elements shown in FIG. 6 have been labeled with the same reference characters as used above to describe the embodiments of the liquid crystal display device shown in FIGS. 1 to 3, and any repetitive detailed description thereof will hereinafter be omitted or simplified.

In some embodiments, as illustrated in FIG. 6, the connection electrodes 188-4, 188-5a may include a first connection electrode 188-4 connected to one end of the body portion 184 and the one end of the extension bar 186, and a second connection electrode 188-5 connected to other end of the body portion 184 and the other end of the extension bar 186. Thus, the opening 188-4a may have a closed structure. In such an embodiment, the opening 188-4a may has a shape that is surrounded by the body portion 184, the extension bar 186, the first connection electrode 188-4 and the second connection electrode 188-5.

In such an embodiment, as shown in FIG. 6, the connection electrodes 188-4, 188-5 are connected to both terminal ends of the extension bar 186, but not being limited thereto.

In an embodiment, the connection electrodes 188-4, 188-5 include the first connection electrode 188-4 and the second connection electrode 188-5. In such an embodiment, the connection electrodes 188-4, 188-5 may further include an additional connection electrode.

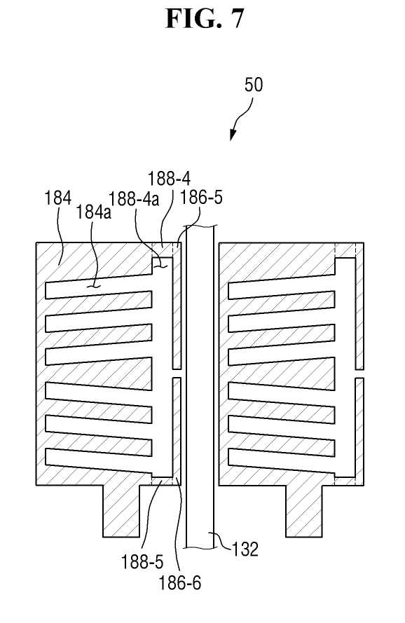

FIG. 7 is a plan view illustrating a pixel electrode structure of the liquid crystal display device according to another alternative embodiment of the invention.

Referring to FIG. 7, an alternative embodiment of a liquid crystal display device 50 is substantially the same as an embodiment of the liquid crystal display device 10 described above with reference to FIGS. 1 to 3 except for the pixel electrode, e.g., the extension bars 186-5, 186-6, and an opening 188-5a thereof. The same or like elements shown in FIG. 7 have been labeled with the same reference characters as used above to describe the embodiments of the liquid crystal display device shown in FIGS. 1 to 3, and any repetitive detailed description thereof will hereinafter be omitted or simplified.

In some embodiments, the extension bars 186-5, 186-6 may include a first extension bar 186-5 and a second extension bar 186-6a that are disposed to be spaced apart from each other in the extension direction as illustrated in FIG. 6, namely, in the first direction or the vertical direction. The other of the first extension bar 186-5 and one end of the second extension bar 186-6 may face each other to be spaced apart from each other. One end of the first extension bar 186-5 may be connected to the first connection electrode 188-4, and one end of the second extension bar 186-6 may be connected to the second connection electrode 188-5. As the first extension bar 186-5 and the second extension bar 186-6 are disposed to be spaced apart from other in the extension direction, that is, in the vertical direction, the opening 188-5a may have an open structure.

The first connection electrode 188-4 may be connected to one end of the body portion 184 and the one end of the first extension bar 186, and the second connection electrode 188-5 may be connected to the other end of the body portion 184 and the other end of the extension bar 186.

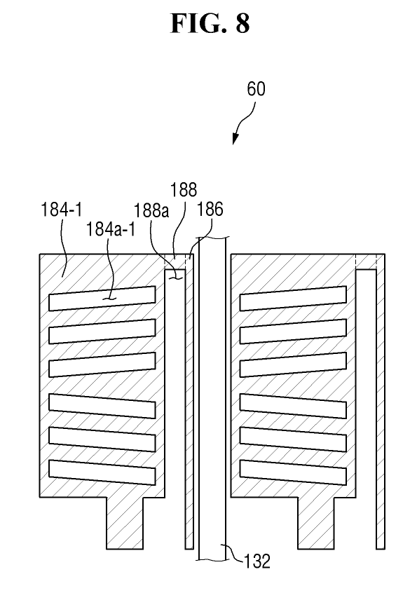

FIG. 8 is a plan view illustrating a pixel electrode structure of the liquid crystal display device according to still another alternative embodiment of the invention.

Referring to FIG. 8, an alternative embodiment of a liquid crystal display device 60 is substantially the same as an embodiment of the liquid crystal display device 10 described above with reference to FIGS. 1 to 3 except for a pixel electrode, e.g., a body portion 184-1 and a slit 184a-1 thereof. The same or like elements shown in FIG. 8 have been labeled with the same reference characters as used above to describe the embodiments of the liquid crystal display device shown in FIGS. 1 to 3, and any repetitive detailed description thereof will hereinafter be omitted or simplified.

In some embodiments, the slit 184a-1 formed in the body portion 184-1 may have a closed structure. In one embodiment, for example, as illustrated in FIG. 8, the slit 184a-1 may have a shape that is formed on the inner side of the body portion 184-1 and is surrounded by the body portion 184-1.

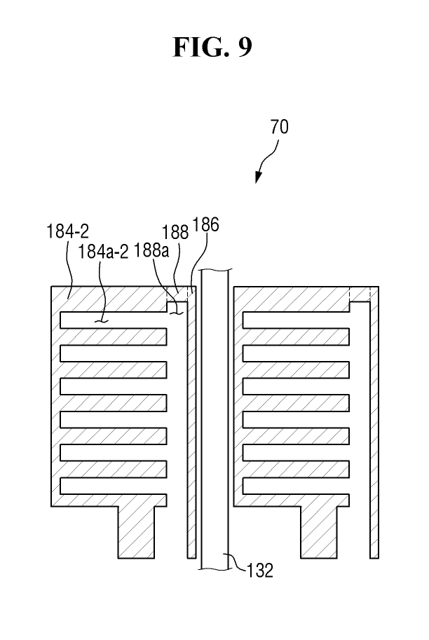

FIG. 9 is a plan view illustrating a pixel electrode structure of a liquid crystal display device according to still another alternative embodiment of the invention.

Referring to FIG. 9, an alternative embodiment of a liquid crystal display device 70 is substantially the same as an embodiment of the liquid crystal display device 10 described above with reference to FIGS. 1 to 3 except for a pixel electrode, e.g., a body portion 184-2 and a slit 184a-2 thereof. The same or like elements shown in FIG. 9 have been labeled with the same reference characters as used above to describe the embodiments of the liquid crystal display device shown in FIGS. 1 to 3, and any repetitive detailed description thereof will hereinafter be omitted or simplified.

In some embodiments, the pixel electrode may define a single domain. In one embodiment, for example, each of the slits 184a-2 formed in the body portion 184-2 may be in parallel to each other in a shape that extends in the second direction or the horizontal direction as illustrated in FIG. 9. In such an embodiment, the slits 184a-2 may be formed in parallel to each other in a shape that extends in the second direction substantially perpendicular to the first direction that is an extension direction of the extension bar 186.

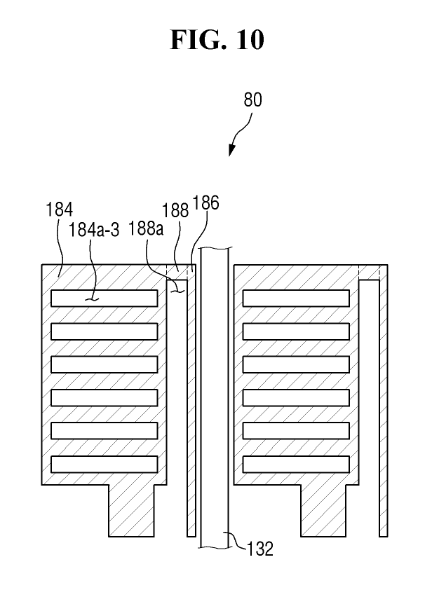

FIG. 10 is a plan view illustrating a pixel electrode structure of a liquid crystal display device according to still another alternative embodiment of the invention.

Referring to FIG. 10, an alternative embodiment of a liquid crystal display device 80 is substantially the same as an embodiment of the liquid crystal display device 10 described above with reference to FIGS. 1 to 3 except for a pixel electrode, e.g., a body portion 184-3 and a slit 184a-3 thereof. The same or like elements shown in FIG. 10 have been labeled with the same reference characters as used above to describe the embodiments of the liquid crystal display device shown in FIGS. 1 to 3, and any repetitive detailed description thereof will hereinafter be omitted or simplified.

In some embodiments, the slit 184a-3 formed in the body portion 184-3 may be provided as a closed structure. In one embodiment, for example, as illustrated in FIG. 10, the slit 184a-3 may be in a shape that is formed on the inner side of the body portion 184-3 and surrounded by the body portion 184-3.

While the embodiments of the invention have been mainly described above, such embodiments are merely examples and are not intended to limit the invention, and it will be understood by those of ordinary skill in the art that various changes and applications that have not been described above may be made without departing from the essential characteristics of the invention. For example, the respective components specifically illustrated in the embodiments of the invention may be practiced with modifications. The difference according to such modifications and applications should be construed as being included in the scope of the invention as defined by the appended claims.

What is claimed is:

1. A liquid crystal display device comprising:
a first substrate;
a second substrate disposed opposite to the first substrate, wherein a plurality of pixel regions is defined in the first substrate or the second substrate;
a liquid crystal layer disposed between the first substrate and the second substrate; and
a pixel electrode comprising:
a body portion disposed in a pixel region on the first substrate, wherein a slit is defined in the body portion;
an extension bar disposed on the first substrate near a boundary line of the pixel region to be spaced apart from the body portion and extending in a first direction, wherein an opening is defined between the body portion and the extension bar, and extends in the first direction; and
a connection electrode disposed on the first substrate and which electrically connects the body portion and the extension bar.

2. The liquid crystal display device of claim 1, further comprising:
a data line disposed on the first substrate and extending in the first direction.

3. The liquid crystal display device of claim 2, wherein at least a part of the extension bar overlaps the data line.

4. The liquid crystal display device of claim 1, wherein the extension bar is disposed inside the pixel region.

5. The liquid crystal display device of claim 3, wherein at least a part of the connection electrode overlaps the data line.

6. The liquid crystal display device of claim 1, wherein
an end of the connection electrode is connected to the body portion, and
another end of the connection electrode is connected to the extension bar.

7. The liquid crystal display device of claim 6, wherein the connection electrode extends in a second direction, which is substantially perpendicular to the first direction.

8. The liquid crystal display device of claim 1, wherein the connection electrode is connected to an end of the body portion and an end of the extension bar.

9. The liquid crystal display device of claim 1, wherein the connection electrode is disposed at a same level as the body portion and the extension bar.

10. The liquid crystal display device of claim 1, wherein
the connection electrode comprises a first connection electrode and a second connection electrode,
the first connection electrode is connected to an end of the body portion and an end of the extension bar,
the second connection electrode is connected to another end of the body portion and another end of the extension bar, and
the opening is surrounded by the body portion, the first connection electrode, the extension bar and the second connection electrode.

11. The liquid crystal display device of claim 1, wherein
the connection electrode comprises a first connection electrode and a second connection electrode,
the first extension bar comprises a first extension bar and a second extension bar,
the other end of the first connection bar faces the one end of the second extension bar to be spaced apart from each other,
the first connection electrode is connected to one end of the body portion and the one end of the first extension bar, and
the second connection electrode is connected to the other end of the body portion and the other end of the second extension bar.

12. The liquid crystal display device of claim 1, wherein the pixel electrode comprises a plurality of domains.

13. The liquid crystal display device of claim 1, wherein
the slit extends in a second direction substantially perpendicular to the first direction.

14. The liquid crystal display device of claim 1, wherein an end of the slit is open.

15. The liquid crystal display device of claim 1, wherein the slit is surrounded by the body portion.

16. The liquid crystal display device of claim 1, wherein
the pixel electrode comprises a first pixel electrode, and a second pixel electrode adjacent to the first pixel electrode, and
data voltages with polarities different from each other are provided to the first pixel electrode and the second pixel electrode, respectively, at a same gate-on timing.

17. The liquid crystal display device of claim 1, further comprising:
a common electrode disposed on the first substrate to overlap the pixel electrode.

18. The liquid crystal display device of claim 1, further comprising:
a light-shielding pattern disposed on the first substrate and along a boundary region of the pixel region; and
a column spacer which is disposed on the light-shielding pattern and defines a single unitary and indivisible unit with the light-shielding pattern.

19. The liquid crystal display device of claim 1, wherein a width of the extension bar is in a range of about 2 micrometers to about 8 micrometers.

20. The liquid crystal display device of claim 1, wherein
the pixel electrode comprises a first pixel electrode, and a second pixel electrode adjacent to the first pixel electrode in a second direction substantially perpendicular to the first direction, and
a spaced distance between the extension bar of the first pixel electrode and the body portion of the second pixel electrode is equal to or less than about 5 micrometers.
